(19) United States
(12) Patent Application Publication
(10) Pub. No.: US 2025/0086712 A1
(43) Pub. Date: Mar. 13, 2025

(54) METHOD AND SYSTEM TO DIGITIZE THE VALUE OF A COMMODITY

(71) Applicant: WGC (UK) LIMITED, London (GB)

(72) Inventors: Mike OSWIN, London (GB); David TAIT, London (GB)

(21) Appl. No.: 18/670,053

(22) Filed: May 21, 2024

Related U.S. Application Data
(60) Provisional application No. 63/537,937, filed on Sep. 12, 2023.

(51) Int. Cl. G06Q 40/04

(52) U.S. Cl. CPC G06Q 40/04

(57) ABSTRACT

A method and system for the digitization and distribution of a commodity value, such as physical gold or other physical asset, which includes standardizing a unit of value for the commodity and creating a standard record to track the purity, weight and location of the standardized unit. The systems and methods also enable the secure and efficient transfer of those asset rights from one to another party. The inventive concepts disclosed herein will be described in connection with physical gold, but a person skilled in this art will understand that these systems and methods can just as efficiently be used with other physical commodities and financial assets without limitation, including any real world and/or tangible assets and/or fiat currencies. The SGU token and PWL token described herein provide a useful, concrete and tangible product that does not require physically relocating an underlying physical asset to effect an ownership transfer of the physical asset.

### RELATED APPLICATION DATA

This application claims the benefit of and priority under 35 U.S.C. § 119(e) to U.S. Patent Application No. 63/537,937, filed Sep. 12, 2023, entitled “METHOD AND SYSTEM TO DIGITIZE THE VALUE OF A COMMODITY,” which is incorporated herein by reference in its entirety.

### FIELD

One exemplary aspect relates at least to a method and system for the digitization and distribution of a commodity value, such as physical gold, which includes standardizing a unit of value for the commodity and creating a standard record to track the purity, weight and location of the standardized unit. The systems and methods also facilitate the secure and efficient transfer of those asset rights from one to another party. The inventive concepts disclosed herein will be described in connection with physical gold, but a person skilled in this art will understand that these systems and methods can just as efficiently be used with other physical commodities and financial assets without limitation, such as, for example, any real-world or tangible asset and/or fiat currencies.

### BACKGROUND

All of the following documents provide background information that helps with the understanding of the current technology, and are hereby incorporated herein by reference in their entirety for all they teach and for all purposes:

(Format: (Publication number-Priority date-Publication date-Assignee-Title)

US20080319912A1 *2007-06-222008-12-25 Faith Patrick L Powering Financial Transaction Token With Onboard And External Power Source

WO2011032257A1 *2009-09-172011-03-24 Royal Canadian Mint/Monnaie Royale Canadienne Asset Storage And Transfer System For Electronic Purses

GB2481563B *2009-12-222017-07-19 Intel Corp Method And Apparatus To Provide Secure Application Execution

WO2012122994A1 *2011-03-112012-09-20 Kreft Heinz Off-Line Transfer Of Electronic Tokens Between Peer-Devices

US20150205929A1 *2014-01-232015-07-23 Dror Samuel Brama Method, System And Program Product For Transferring Genetic And Health Data

US20150262168A1 *2014-03-172015-09-17 Coinbase, Inc. Instant Exchange

US20150363769A1 *2014-06-162015-12-17 Bank Of America Corporation Cryptocurrency Real-Time Conversion System

US20,160,028552A1 *2014-07-252016-01-28 Blockchain Technologies Corporation System And Method For Creating A Multi-Branched Blockchain With Configurable Protocol Rules

US20160182230A1 *2014-12-232016-06-23 Nxp B.V.Secure Token-Based Signature Schemes Using Look-Up Tables

US20160203448A1 *2014-07-032016-07-14 Raise Marketplace Inc. Cryptocurrency Verification System

US20160210460A1 *2015-01-202016-07-21 Mediatek Inc. Methods For Operating Electronic Devices, And Electronic Devices

US20160261411A1 *2012-11-282016-09-08 Hoverkey Ltd. Method And System Of Providing Authentication Of User Access To A Computer Resource Via A Mobile Device Using Multiple Separate Security Factors

US20160269367A1 *2015-03-132016-09-15 HGST Netherlands B.V. Controlling Encrypted Data Stored On A Remote Storage Device

US20160275461A1 *2015-03-202016-09-22 Rivetz Corp. Automated Attestation Of Device Integrity Using The Block Chain

US20160275513A1 *2015-03-182016-09-22 Ca, Inc. System And Method Of Neutralizing Mobile Payment

US20160301531A1 *2015-04-092016-10-13 Qualcomm Incorporated Proof Of Work Based User Identification System

US20170054619A1 *2015-08-212017-02-23 Barefoot Networks, Inc. Fast Detection And Identification Of Lost Packets

U.S. Pat. No. 9,635,000B1 *2016-05-252017-04-25 Sead Muftic Blockchain Identity Management System Based On Public Identities Ledger

US20170124557A1 *2015-11-042017-05-04 The Toronto-Dominion Bank Token-Based System For Excising Data From Databases

US20170132621A1 *2015-11-062017-05-11 SWFL, Inc., D/B/A “Filament” Systems And Methods For Autonomous Device Transacting

U.S. Pat. No. 9,667,600B2 *2015-04-062017-05-30 At&T Intellectual Property I, L.P. Decentralized And Distributed Secure Home Subscriber Server Device

US20170270528A1 *2016-03-182017-09-21 Gyan Prakash Location Verification During Dynamic Data Transactions

U.S. Pat. No. 9,774,578B1 *2016-05-232017-09-26 Accenture Global Solutions Limited Distributed Key Secret For Rewritable Blockchain

WO2017184913A1 *2016-04-222017-10-26 Autolotto, Inc. System And Method For Purchasing Lottery Tickets

WO2017190057A1 *2016-04-302017-11-02 Civic Technologies, Inc. Methods And Apparatus For Providing Attestation Of Information Using A Centralized Or Distributed Ledger

WO2017218440A1 *2016-06-132017-12-21 Cloudmode, LLC Secure Initiation And Transfer Of A Cryptographic Database And/Or A Cryptographic Unit

US20170364450A1 *2015-06-022017-12-21 ALTR Solutions, Inc. Immutable Datastore For Low-Latency Reading And Writing Of Large Data Sets

U.S. Pat. No. 9,881,176B2 *2015-06-022018-01-30 ALTR Solutions, Inc. Fragmenting Data For The Purposes Of Persistent Storage Across Multiple Immutable Data Structures

U.S. Pat. No. 9,904,516B2 *2014-12-232018-02-27 Nxp B.V. Modular Exponentiation Using Look-Up Tables

U.S. Pat. No. 9,906,368B2 *2014-12-232018-02-27 Nxp B.V. General Encoding Functions For Modular Exponentiation Encryption Schemes

US20180096349A1 *2016-10-052018-04-05 The Toronto-Dominion Bank Distributed Electronic Ledger With Metadata

US20180101906A1 *2016-10-072018-04-12 The Toronto-Dominion Bank Secure Element Method For Distributed Electronic Ledger

CN108009918A *2017-11-232018-05-08 The Bookkeeping Methods And Electronic Equipment Of Block Chain Common Recognition Algorithm Transaction System

CN108021813A *2016-11-022018-05-01 Method For Protecting The Transaction Performed From Non-Security Terminal

U.S. Pat. No. 9,985,784B2 *2014-12-232018-05-29 Nxp B.V. Efficient Smooth Encodings For Modular Exponentiation

US20180152289A1 *2016-11-302018-05-31 International Business Machines Corporation Checkpoints For Permissionless Blockchains

US20180150799A1 *2016-11-302018-05-31 International Business Machines Corporation Blockchain Checkpoints And Certified Checkpoints

WO2018119300A1 *2016-12-232018-06-28 Amazon Technologies, Inc. Generation Of Merkle Trees As Proof-Of-Work

US20180182057A1 *2016-12-272018-06-28 Fotonation Limited Systems And Methods For Detecting Data Insertions In Biometric Authentication Systems Utilizing A Secret

U.S. Pat. No. 10,033,732B1 *2016-11-092018-07-24 Symantec Corporation Systems And Methods For Detecting Cloning Of Security Tokens

U.S. Pat. No. 10,050,942B2 *2015-03-172018-08-14 Ca, Inc. System And Method Of Mobile Authentication

US20180262341A1 *2017-03-102018-09-13 Fmr Llc Secure Firmware Transaction Signing Platform Apparatuses, Methods And Systems

US20180276931A1 *2016-12-072018-09-27 Selfdot Technologies (Opc) Pvt Ltd Method For Automated Authentication Of A Security Label

WO2018175058A1 *2017-03-242018-09-27 Mastercard International Incorporated Method And System For Offline Data Transfer Via Machine-Readable Code

US20180285839A1 *2017-04-042018-10-04 Datient, Inc. Providing Data Provenance, Permissioning, Compliance, And Access Control For Data Storage Systems Using An Immutable Ledger Overlay Network

US20180293556A1 *2017-04-052018-10-11 Samsung Sds. Co., Ltd. Method And System For Processing Blockchain-Based Real-Time Transaction

US20180330360A1 *2016-01-252018-11-15 Alibaba Group Holding Limited Credit Payment Method And Apparatus Based On Card Emulation Of Mobile Terminal

US20180332692A1 *2015-11-132018-11-15 Osram Gmbh Lighting Device For Communicating With A Mobile Terminal

US20180337773A1 *2017-05-192018-11-22 Fujitsu Limited Communication Device And Communication Method

US20180349901A1 *2016-01-252018-12-06 Alibaba Group Holding Limited Credit Payment Method And Apparatus Based On Mobile Terminal Peer-To-Peer

US20180352435A1 *2017-06-042018-12-06 Apple Inc. Migration For Wearable To New Companion Device

WO2018201147A3 *2017-04-282018-12-13 Neuromesh Inc. Methods, Apparatus, And Systems For Controlling Internet-Connected Devices Having Embedded Systems With Dedicated Functions

CN109074576A *2016-04-292018-12-21 Implementing Logic Gate Functions Using Blockchains

WO2019028026A1 *2017-07-312019-02-07 Chronicled, Inc. A Secure And Confidential Custodial Transaction System, Method And Device Using Zero-Knowledge Protocol

US20190068460A1 *2017-08-242019-02-28 International Business Machines Corporation Localized Sensor Quality Analysis And Control

CN109462472A *2017-09-062019-03-12 The Methods, Devices And Systems Of Data Encryption And Decryption

KR20190025942A *2016-07-052019-03-12 Block Chain For Controlling External Processes Or Systems-Implementation Control Method And System

CN109478280A *2016-07-292019-03-15 Method And System For Realizing Block Chain

U.S. Pat. No. 10,235,538B2 *2016-02-022019-03-19 Coinplug, Inc. Method And Server For Providing Notary Service For File And Verifying File Recorded By Notary Service

WO2019055432A1 *2017-09-132019-03-21 Stojanovski Jordan Cash-Equivalent Device For Digital Currencies

WO2019067863A1 *2017-09-282019-04-04 Silvio Micali Message-Credentialed Blockchains

US20190102404A1 *2017-10-022019-04-04 Comcast Cable Communications Management, Llc Multi-Component Content Asset Transfer

CN109583885A *2017-09-012019-04-05 Bout Controls Rewritable Block Chain

WO2019071026A1 *2017-10-042019-04-11 Jintai Ding Quantum Proof Blockchain

US20190108482A1 *2017-10-062019-04-11 Sap Se Enablement Of Procurement Processes With Asset Traceability Using Blockchain Technology

US20190118094A1 *2017-10-252019-04-25 Sony Interactive Entertainment LLC Blockchain Gaming System

US20190141158A1 *2016-08-022019-05-09 Wangsu Science & Technology Co., Ltd. Acceleration Method, Device, And System For P2p Data

US20190182035A1 *2017-12-122019-06-13 International Business Machines Corporation Protection Of Confidentiality, Privacy And Financial Fairness In A Blockchain Based Decentralized Identity Management System

CN110032865A *2019-03-282019-07-19 A Kind Of Right Management Method, Device And Storage Medium

U.S. Pat. No. 10,360,558B2 *2015-03-172019-07-23 Ca, Inc. Simplified Two Factor Authentication For Mobile Payments

U.S. Pat. No. 10,366,247B2 *2015-06-022019-07-30 ALTR Solutions, Inc. Replacing Distinct Data In A Relational Database With A Distinct Reference To That Data And Distinct De-Referencing Of Database Data

U.S. Pat. No. 10,387,884B2 *2015-03-182019-08-20 Ca, Inc. System For Preventing Mobile Payment

U.S. Pat. No. 10,397,003B2 *2017-02-102019-08-27 International Business Machines Corporation Signature Scheme For Homomorphic Message Encoding Functions

US20190325406A1 *2014-05-192019-10-24 OX Labs Inc. System And Method For Rendering Virtual Currency Related Services

US20190332552A1 *2018-04-252019-010-31 Blockchain Asics Llc Cryptographic Asic With Onboard Permanent Context Storage And Exchange

U.S. Pat. No. 10,482,034B2 *2016-11-292019-11-19 Microsoft Technology Licensing, Llc Remote Attestation Model For Secure Memory Applications

US20190356484A1 *2018-05-152019-11-21 Mfe Capital, Llc Device For Off-Line Storage And Usage Of Digital Assets

US20190370446A1 *2014-02-042019-12-05 Lenovo (Singapore) Pte. Ltd. Biometric Account Card

U.S. Pat. No. 10,504,179B1 2015-12-082019-12-10 Fmr Llc Social Aggregated Fractional Equity Transaction Partitioned Acquisition Apparatuses, Methods And Systems

WO2020009771A1 *2018-07-032020-01-09 Wandisco, Inc. Methods, Devices And Systems For A Distributed Coordination Engine-Based Exchange That Implements A Blockchain Distributed Ledger

CN110719522A *2019-10-312020-01-21 Video Display Method And Device, Storage Medium And Electronic Equipment

U.S. Pat. No. 10,579,779B2 *2016-05-132020-03-03 Nchain Holdings Limited Method And System For Verifying Integrity Of A Digital Asset Using A Distributed Hash Table And A Peer-To-Peer Distributed Ledger

WO2020046786A1 *2018-08-272020-03-05 Fireblocks Ltd. System And Method For Securing Crypto-Asset Transactions

US20,200,092105A1 *2016-12-212020-03-19 Nchain Holdings Limited Computer-Implemented Systems And Methods To Enable Complex Functionality On A Blockchain While Preserving Security-Based Restrictions On Script Size And Opcode Limits

U.S. Pat. No. 10,600,050B1 *2019-03-222020-03-24 Onli, Inc. Secure Custody Of A Ledger Token And/Or A Quantity Of Cryptocurrency Of A Distributed Ledger Network Through Binding To A Possession Token

CN110998572A *2017-08-042020-04-10 Self-Verification User Authentication Method Based On Time-Dependent Blockchain

U.S. Pat. No. 10,644,879B2 *2015-05-192020-05-05 Coinbase, Inc. Private Key Decryption System And Method Of Use

U.S. Pat. No. 10,644,885B2 *2015-07-142020-05-05 Fmr Llc Firmware Extension For Secure Cryptocurrency Key Backup, Restore, And Transaction Signing Platform Apparatuses, Methods And Systems

U.S. Pat. No. 10,649,754B2 *2015-01-282020-05-12 Ricoh Company, Ltd. Image Processing Device And Electronic Whiteboard

U.S. Pat. No. 10,650,621B1 2016-09-132020-05-12 Iocurrents, Inc. Interfacing With A Vehicular Controller Area Network

U.S. Pat. No. 10,659,223B2 *2016-02-232020-05-19 Nchain Holdings Limited Secure Multiparty Loss Resistant Storage And Transfer Of Cryptographic Keys For Blockchain Based Systems In Conjunction With A Wallet Management System

U.S. Pat. No. 10,671,315B2 *2018-08-172020-06-02 Bank Of America Corporation Blockchain Architecture For Selective Data Restore And Migration

U.S. Pat. No. 10,671,515B1 *2018-11-302020-06-02 Bank Of America Corporation Recording And Playback Of Electronic Event Sequence In A Distributed Ledger System

US20200204510A1 *2018-12-212020-06-25 Chicago Mercantile Exchange Inc. Multiple Chain Message Data Recordation With Adjustable Visibility Permissioning

U.S. Pat. No. 10,715,336B2 *2016-02-232020-07-14 Nchain Holdings Limited Personal Device Security Using Elliptic Curve Cryptography For Secret Sharing

U.S. Pat. No. 10,740,763B2 *2017-03-292020-08-11 Alibaba Group Holding Limited Blockchain-Based Transaction Processing Method And Apparatus

U.S. Pat. No. 10,778,439B2 *2015-07-142020-09-15 Fmr Llc Seed Splitting And Firmware Extension For Secure Cryptocurrency Key Backup, Restore, And Transaction Signing Platform Apparatuses, Methods And Systems

U.S. Pat. No. 10,790,988B1 *2019-09-022020-09-29 Alibaba Group Holding Limited Managing Blockchain-Based Centralized Ledger Systems

U.S. Pat. No. 10,790,990B2 *2019-06-262020-09-29 Alibaba Group Holding Limited Ring Signature-Based Anonymous Transaction

CN111786857A *2020-07-032020-10-16

The problems associated with tracking and trading assets by means of a physical object, such as physical gold or other precious metal, has been extensively studied and dates back to the origin of money. The history of money concerns the development of means of carrying out transactions involving a physical medium of exchange, where money is any clearly identifiable object of value that is generally accepted as payment for goods and/or services. Many things have been used as a medium of exchange in markets including, for example, livestock and sacks of cereal grain, and various metals, things that are directly useful in and of themselves, as well as coins and banknotes that represent value.

Banknotes, coins, precious metals, etc., have many advantages, such as reduced manufacturing costs, but also have disadvantages, such as wear, transport, and storage costs. A system for transferring value of an object without transferring a physical object typically included means such as credit cards, and later, digital currencies. With the advent of the Internet, several systems for paying remotely were developed, such as PayPal®, which allowed transactions to be performed using pre-existing standard monetary units.

The appearance of virtual currencies has resulted in the creation of new units of accounts. A virtual currency that can be bought with and sold back for legal tender is called a convertible currency. It can be centralized, as in Linden Dollars in the online virtual economy of Second Life or decentralized, as for example Bitcoin®. In both cases, the owner of each asset is managed by a known asset tracking system. The owner of the asset need not be an identified individual and each asset is associated with a code, so the real entity owning the asset may remain anonymous. A cryptocurrency (also called peer-to-peer currency) is such a virtual currency which can be traded by using cryptography, and the use of digital signatures. With digital signatures, the transfer of the asset is allowed by the owner by signing a specific message (called a transaction) with a private-key and making the message and the signature available to the asset tracking system. However, these virtual currencies are often considered to be ethereal and not connected with or tethered to anything of real value.

These object-value-transfer challenges persist, even in the context of gold, which is one of the most traded commodities in the world, ranking only behind the S&P 500 and U.S. Treasuries in traded asset volumes. London is the largest Over the Counter (“OTC”) gold market, with almost $41 billion of gold cleared each day (LBMA, April 23). Worldwide, the volumes of gold trading are similar. Despite these massive volumes and values, the gold market, as with many commodity markets, still faces challenges, including at least the following:
Complete settlement and value transfer require a physical shipment of gold. The physical shipment of gold itself takes time (up to five days after the transaction), incurs costs, and reduces resilience when there are business continuity issues, as was demonstrated in the early days of the COVID-19 pandemic. Also, physical gold is not always fungible, as different markets prefer or require gold of different weights, purities and formats.
The gold OTC market would benefit from more pre- and post-trade transparency as is the case with exchange-traded markets. The market is reserved for a smaller pool of market participants, and it can be difficult to obtain real-time information about prices and volumes.
There are risks, including both operational and counterparty risk as there is no central counterparty (CCP) clearing function for gold, as well as settlement and location risk when trying to claim back physical gold. Even though gold is considered an eligible asset to cover margin under the ISDA rules, it is very rarely, or indeed never, put up as collateral because of these risks and significant haircut costs.
Gold is not currently considered to be a High-Quality Liquid Asset (HQLA) under certain regulatory frameworks, such as Basel III standards. The current challenges do not allow the classification of gold as a high-quality liquid asset-cash or assets that can be converted into cash quickly through sales or by being pledged as collateral, with no significant loss of value. Due to these challenges, there are higher capital requirements when using and holding gold as compared to other assets.
Inefficiencies in trading processes cause higher margin requirements because the current infrastructure is dated. There are also discrepancies across custody and infrastructure costs, resulting in differences across jurisdictions.

A crucial initial step in addressing the described challenges and inefficiencies will be driven by improving trust and transparency, which can be achieved by leveraging digital technology to allow those participating in the gold production, distribution and ownership ecosystem to define transparent workflows, with real-time access to data and status, that provide visibility into the use of physical gold, resulting in a model of greater trust, confidence and security. Use of such technology will also promote a more interconnected and efficient market, which should reduce overall market risks, enhancing the value of the commodity and improving commodity ownership worldwide.

A need thus exists for the development of a standard commodity unit, such as a Standard Gold Unit (“SGU”), and for a system to assign efficiently and effectively, track, and allocate these units. The units also need to be fully backed by a physical commodity of a known type at all times that is situated in a known and secure location. A further need exists to create consistency and confidence in the system to facilitate the entire process for trading digitized commodities.

### SUMMARY

The fragmented nature of the gold market, as with many commodity markets, can be addressed by creating a trusted ecosystem interconnecting all accredited stakeholders within a particular network. Such a trusted ecosystem can preferably offer a unique opportunity for the gold market to create a common interface between all participants, including, miners, refiners, banks, traders, custodians, vaults, investors, trustees, and administrators, that enables seamless data interactions between one another's systems. Indeed, there are multiple areas of possible improvement in the OTC gold market, including opportunities to:
Create a trusted and transparent digital ecosystem for gold;
Modernize the gold market infrastructure, thereby mitigating current market risks;
Increase participation and new uses of gold with ease in trading, allocation, and transfer of physical gold;
Reliably track provenance and integrity of physical gold; and
Support the case for enabling gold as a high-quality liquid asset.

Indeed, with the advent of smart contract and blockchain technology, it has become possible to standardize, digitize and thus more easily monetize various commodities, such as gold. The market transformation begins with the creation of the SGU that preferably expresses desired attributes of physical gold with its differing attributes of purity, weight, and location, into a standardized digital unit format. As an example, an SGU could represent 1 ounce of pure gold, 1 oz of 999.9 (4 nines) purity, or 1 gram of 995.0. Three important, but not exclusive, considerations for these preferred SGUs are:
Fungibility—An SGU is a fungible data asset that is backed by a minimum standard of gold but not tied to any specific gold bar.
Transparency—Clarity comes from the data attributes captured for the physical gold and stored separately to the SGU.
Increased Utility—An SGU is an easy-to-use vehicle for investors to gain access to economic opportunities while also catering to the wholesale market's specific requirements/preferences, ultimately leading to the emergence of new markets and utility for gold.

An SGU may be illustratively formed by creating two digital records: a SGU token that contains only the economics/value of the gold and a Purity, Weight & Location (“PWL”) token containing the gold bar's physical attributes of purity, weight and location. It is this PWL token that provides the token holder with the right to redeem the SGU(s) from the ecosystem and withdraw a gold bar that matches those 3 attributes (note: other attributes such as brand and serial number need not be recorded in the PWL token to preserve the principle of maximum fungibility). An SGU Integrity Database can preferably be used to hold some to all of this digital information pertaining to the physical gold bar and its attributes.

The total ecosystem for this disclosure will now be explained with reference to FIG. 1. Miners and refiners produce physical gold which may be utilized for investment purposes and preferably stored in secure, trusted vaults, often under the guardianship of an industry custodian. The custodian (or Authorized SGU Creator) can provide relevant information concerning the received gold and its physical purity, weight and location to the SGU trustee and administrator, who authorizes the creation of the SGU and PWL Tokens. Those Tokens are initially created together in the SGU Standardization Database, but their ownership can be split or combined as desired-they are not inextricably linked after creation. During the Token creation process, the administrator can place the Tokens, or some or all information concerning the Tokens, into the SGU Integrity Database, with the initial gold digitization process then being complete. The now digitized gold can be utilized as an individual SGU, which is completely fungible and interchangeable with every other SGU, bundled into multiple SGUs, bundled with PWL Tokens to create, for example, digital representations of a 400 oz, 995.0 purity Good Delivery bar located in London or a 1 kilo, 999.9 purity bar located in Switzerland, etc. (collectively “Products”). These Products are free to be bought and sold on digital exchanges, either wholesale or retail, or utilized to underpin a wide range of gold-backed investment products such as ETFs or asset backed coins and tokens, or to provide utility tokens for the purposes of pledging gold as collateral or as a settlement token for the global OTC market, or otherwise in ways well known in the art. There are no limitations, other than those prescribed by or restricted under law, as to how the Tokens can be utilized separately or combined to create new and innovative products, that as of today cannot exist.

In an example of one exemplary embodiment of the ecosystem, physical gold can be registered on a blockchain or distributed ledger (DLT) network, creating an immutable record of that gold, always ensuring that physical gold backs any digital SGUs in the ecosystem. At any point, an administrator will also be able to have complete oversight of all the physical gold and digital tokens within the ecosystem. The disclosed system will also facilitate trading of gold and other commodities between regions and countries. Digitalization with the SGU and PWL Tokens makes trading between regions easier, as the movement of physical gold between vaults would not be necessary. With the SGU and PWL Tokens, fungibility of the commodity becomes real. Furthermore, PWL Tokens will help create a new market where the right to a physical commodity, or gold bar of predefined attributes, can be traded across regions. Digitalization also opens the possibility of Delivery versus Payment (DvP) in the wholesale market, without the need to wait for up to five days for physical gold to be transferred, minimizing both credit and settlement risk, which should offer the market a favorable risk profile and reduce margin requirements, increasing overall liquidity.

More specifically, the administrator can preferably oversee the SGU ecosystem. It is the entity that will govern the other various ecosystem participants and locations that can be part of the ecosystem. The administrator will oversee trustees and monitor and verify the assets that meet the specification to be accepted into the ecosystem and thereby become eligible for SGU and PWL creation within the ecosystem. As part of its role, an administrator will create the specifications for the eligibility of gold to become SGUs and PWLs and maintain the blacklist of any gold, participants or criteria that would not be acceptable. The administrator is also responsible for creating the tokens representing SGUs and PWLs, providing them to the participant, and archiving them when appropriate. There can only be one administrator within the ecosystem, and the administrator could also be the group that operates the technical system or has contract functions. When there is a need for any outside platforms to back into or out of this SGU ecosystem, which is expected to be the case, it would preferably go through the administrator.

Additionally, the trustee, who can be an independent validator of the gold, preferably inputs details (such as purity, weight, and location) of gold (or another commodity) into the SGU Integrity Database, once approved by the administrator in a preferred system, so that it has been registered into the trusted ecosystem. By doing so, the trustee confirms that there is physical gold to back an SGU. The trustee also takes on the responsibility of the legal ownership of the physical gold when it has been calculated and digitalized as SGUs. Once all verification checks have been completed, trustees can retain ownership of the physical gold until the digitalized SGUs have been archived. The trustees are preferably a separate legal structure distinct from the administrator. There can be many trustees within the ecosystem, with a suggestion being to have one at each secure gold storage location.

With reference to FIG. 2, an Integrity Database is shown as being introduced into the ecosystem. The Integrity Database can be used to trace the universal integrity and provenance of a commodity, such as gold, being provided to trustees by producers of the commodity, such as miners, refiners, custodians, and investors. Again, that data can be passed to the trustee and linked to information about the gold being stored by the trustee. The data can also be made available to the administrator. FIG. 2 also describes how, in greater detail than shown in FIG. 1, the SGU Integrity Database is constructed. Next, the figure shows that the Tokens, also referred to as certificates for the purposes of this Figure, can be deposited into an account of an owner or custodian, sometimes referred to as a participant, noting these accounts can be international in nature. Finally, FIG. 2 describes how the Products can be bought and sold as tradeable instruments or leveraged as utility tokens, as previously described.

Several terms are used in this disclosure that are not used in common parlance and definitions therefore may be useful. Accordingly, the inventors here provide a list of terms and definitions that can be used to better understand the disclosure:

| Term | Definition |
|---|---|
| Administrator | Provides oversight over the whole SGU ecosystem; governs |
| | the Participants / locations that can be part of this ecosystem |
| Authorized SGU Creator | Actor who owns or is the custodian of physical gold of a |
| | certain specification or standard and who has the ability to |
| | pledge gold into the SGU environment |
| PWL Token | Secondary token of a digitalized SGU that provides the right |
| | to withdraw the SGU in return for a gold bar of a specified |
| | purity, weight and location - the location at which the |
| | physical gold is stored |
| SGU (Standard Gold Unit) | Standardized digital format for a unit of gold that is |
| | backed by physical gold of an established weight, purity, |
| | and location |
| SGU Integrity Database | Top-level trusted database where gold bar details are |
| | input for future digitalization |
| SGU Standardization Database | Database that is a sub-ledger of the Integrity Database, |
| | where all the details of the SGUs and their digital tokens |
| | are stored |
| SGU Token | Primary token of a digitalized SGU that contains the |
| | economics / value of the gold |
| Tokens | SGU Token and PWL Token |
| Trustee | Independent validator of the gold, inputting the gold's |
| | details into the Integrity Database so that it has been |
| | registered into the trusted ecosystem |
| Vault | Where physical gold is kept |

There are many use cases for digitalized SGUs, with the following being just two that illustrate how the SGU can meet the aspirations of increased participation and increased utility of gold. Note that similar uses cases could be developed for other commodities.

### Case 1—New Trading Markets

With the digitalized SGUs along with the PWL Token, it is possible to trade within several new markets. For example, for wholesale investors, certain risk factors, such as settlement and credit risk, rank high when making trades with counterparties. Knowing that the physical gold is of a certain standard and in a higher-regarded trusted location will be important to such investors, and hence they will look to trade both the SGU Token and the PWL Token together.

However, a wholesale investor who is more of a speculator in gold and who is not actually concerned about holding physical gold may be looking to profit by driving differentials, and they will utilize the option to trade just the SGU or the PWL Tokens alone. This same principle would also apply to a retail investor who now can trade digital gold. As the retail investor may only be trading the SGU, to redeem the physical gold, they would need to pay a premium to one of the location vaults for that gold, effectively buying a PWL Token for that location.

Many new markets can be created with the digitalized SGU, with its options for speculative and locational gold trading without the need for physical settlement, and this will surely be of interest to traders. In addition, as the market and technology progress, there is the chance to eliminate credit and settlement risk—especially for standard gold OTC trading where one has these risks between the NYC cash leg and the London physical gold settlement leg. This will happen with atomic settlement that will be able to occur as two digital tokens are traded simultaneously.

### Case 2—Gold as Collateral

The Collateral use case shows how digital gold can be a fully trusted and mobile asset to cover margin calls, which is not the case today. As mentioned previously, gold is widely accepted as collateral in most collateral schedules, but it is never used because of its long physical settlement time. Creating SGUs will allow gold that has just been sitting in the vaults to be mobilized as a liquid asset. Furthermore, the certainty that the SGUs are backed by physical gold of known integrity will drive confidence in the use of SGUs as preferred collateral. To add to this confidence, when agreeing on the use of SGUs as collateral and the eligibility schedule, settlement facilities and collateral agents can bring into it the location factor, for example, only allowing representations of 400 oz bars located in London, as these are the most convenient and trusted gold bars for the banks.

With sufficient adoption, gold as collateral can lead to a whole new securities lending market, as it would be cheaper to borrow and put up SGUs than to own them. Furthermore, natural long hedgers in industry (e.g., asset managers, private banks) could accumulate PWL Tokens and then lend out into the market. This would increase liquidity in the market as well as create a trading market around PWL Tokens for buy- and sell-side firms.

### BRIEF DESCRIPTION OF THE FIGURES

Exemplary embodiments of the invention are represented in the drawing and are described in more detail with reference to them hereafter, in which:

FIG. 1 illustrates an exemplary block diagram of the SGU ecosystem according to an exemplary embodiment.

FIG. 2 illustrates an exemplary block diagram of the SGU ecosystem of FIG. 1 in greater detail according to an exemplary embodiment.

FIG. 3 illustrates an exemplary hardware diagram that can be used to implement the SGU ecosystem according to an exemplary embodiment.

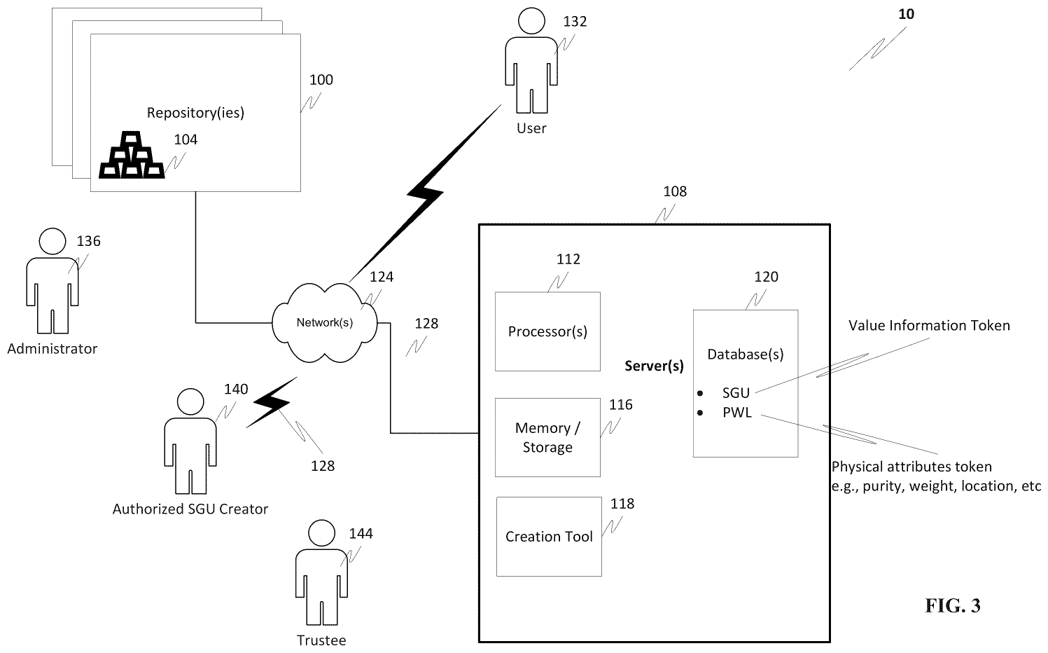

FIG. 4 is a flowchart illustrating exemplary operation and use of a SGU according to an exemplary embodiment.

### DETAILED DESCRIPTION

Detailed embodiment of the inventive system and methods and of various ways of implementing them are disclosed herein. These systems and methods may in part be implemented in various ways known in the prior art, including the art identified below, with the systems, methods and disclosures of that art all being incorporated in their entirety herein by this reference.

Further, it is to be understood that these embodiments are merely examples and that the systems and methods described can be embodied in various forms. Therefore, specific structural and functional details disclosed herein are not to be interpreted as limiting, but merely as a basis for any claims to be pursued and as a representative basis for teaching one skilled in the art to variously employ the present subject matter in virtually any appropriately detailed structure and function. Further, the terms and phrases used herein are not intended to be limiting, but rather, to provide an understandable description of the concepts.

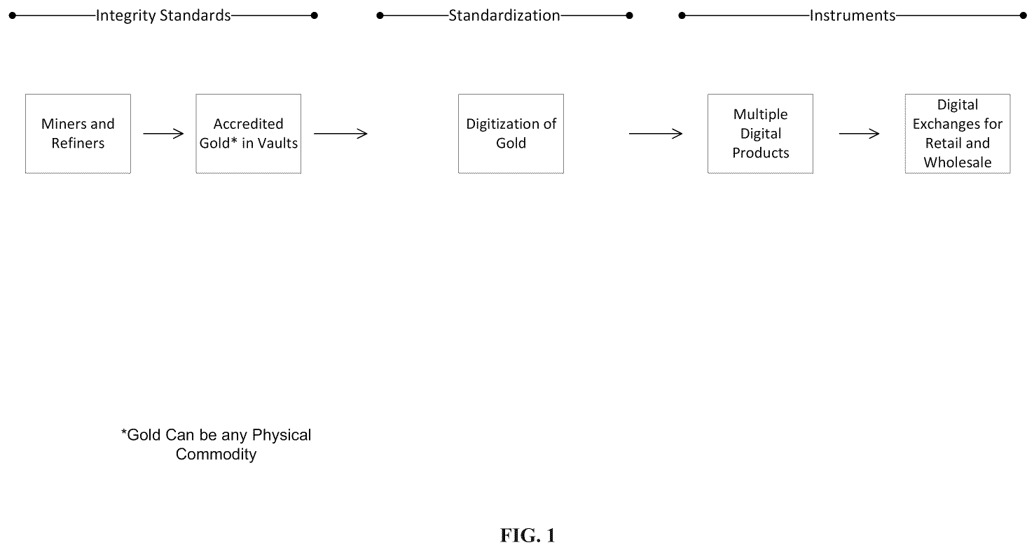

FIG. 1 illustrated an exemplary SGU ecosystem 10. The exemplary system 10 includes one or more repositories 10 that securely store gold 104, one or more servers 108, each comprising one or more processors 112, memory 116, a creation tool 118 and one or more databases 120 that can also be associated with one or more distributed ledgers, such as a blockchain. The system 10 also includes one or more users 132, one or more administrators 136, one or more authorized SGU creators 140 and one or more trustees 144. The various elements can communicate via one or more wired or wireless networks such as network 124 and wired or wireless communications links 128. The users 132, administrators 136, and authorized SGU creators 140 can also interact and communicate with the various elements wired and or wirelessly, and can also physically deposit, inspect and deposit gold in the repository(ies) 100.

An SGU may be illustratively formed by an authorized SGU creator 140 using the creation tool 118 (such as a user interface and associated programming) by creating two digital records: a SGU token that contains information relating to the economics/value of the gold and a Purity, Weight & Location (“PWL”) token that contains information relating to the gold bar's physical attributes of purity, weight and location. This authorized SGU creator 140 will possess the necessary credentials and have a certain level of trust and authority to be able to create a SGU. As will be appreciated, the information in these tokens can be different and/or adapted based on the underlying item of value that the SGU represents, as the item of value can be any item of value and is not limited to gold as discussed herein.

It is this PWL token that provides the token holder, e.g., user 132, with the right to redeem the SGU(s) from the ecosystem 10 and withdraw a gold bar(s) 104 from repository 100 that matches the three named attributes. This withdrawal results in the transformation/conversion of the SGU into a physical object, e.g., gold. (Note: other attributes such as brand and serial number need not be recorded in the PWL token to preserve the principle of maximum fungibility). The database 120 (optionally in conjunction with a distributed ledger system (not shown) such as a blockchain) can optionally also be used to hold some to all of this digital information pertaining to the physical gold bar and its attributes.

As discussed in relation to gold, miners and refiners produce physical gold which may be utilized as discussed above and can be stored in secure, trusted vaults, e.g., repositories 100, often under the guardianship of an industry custodian. The custodian (or Authorized SGU Creator 140) can provide relevant information concerning the received gold 104 in the repository 100 and its physical purity, weight and location information to the SGU trustee 144 and administrator 136, who authorizes the creation of the SGU and PWL Tokens in the server 108.

These tokens are initially created together in the database 120, but their ownership, as discussed, can be split or combined as desired-they are not inextricably linked after creation and can reside in different servers and/or be stored on a blockchain. During the token creation process, the administrator 136 can place the tokens, or some or all information concerning the tokens, into the database 120, with the initial gold digitization process then being complete.

The now digitized gold, e.g., a representation of the physical gold 104, can be utilized as an individual SGU, or multiple SGUs, which is/are completely fungible and interchangeable with every other SGU, bundled into multiple SGUs, bundled with PWL Tokens to create, for example, digital representations of a 16 oz, 995.0 purity bar located in London Bank or a 1 kilo, 999.9 purity bar located in Switzerland, etc. (collectively “Products”), or the like.

These Products are free to be bought, sold, exchanged, traded, auctioned, bartered, or the like, on exchanges, digital exchanges, or the like (not shown) either wholesale, retail, business-to-business, person-to-person, entity-to-entity, or the like, or utilized to underpin or guarantee any gold-backed investment products such as ETFs or asset backed coins and tokens, and/or to provide utility tokens for the purposes of pledging gold as collateral or as a settlement token for the global OTC market, or otherwise in ways well known in the art and as discussed herein. There are no limitations, other than those prescribed by or restricted under law, as to how the Tokens can be utilized separately or combined to create new and innovative products, that as of today cannot exist.

In an example of one exemplary embodiment of the ecosystem 10, physical gold can be registered on a blockchain or distributed ledger (DLT) network (not shown), creating an immutable record of that gold 104, always ensuring that physical gold backs any digital SGUs in the ecosystem 10. At any point, an administrator 136 can have complete oversight of all the physical gold 104 and digital tokens within the ecosystem 10. The disclosed system can also facilitate trading of gold and other commodities between regions and/or countries.

Digitalization of the gold 104 with the SGU and PWL Tokens at least makes trading between regions easier, as discussed, as the movement of physical gold 104 between vaults/regions/countries is no longer required. With the SGU and PWL Tokens, fungibility of the commodity becomes real, easy, secure and more available.

In accordance with an exemplary embodiment, the administrator 136 can optionally oversee the SGU ecosystem 10. The administrator 136 can be the entity that governs, monitors and manages the other various ecosystem participants and locations that can be part of the ecosystem. The administrator 136 can will oversee trustees 144 and monitor and verify the assets that meet the specification to be accepted into the ecosystem and thereby become eligible for SGU and PWL creation within the ecosystem. This process can also optionally be validated through a third-part auditor to ensure asset integrity.

As part of its role, the administrator 136 can create the specifications for the eligibility of gold to become SGUs and PWLs and maintain the blacklist of any gold, participants or criteria that would not be acceptable. Similarly, a whitelist could be maintained for any known historically good gold, participants or criteria that are generally acceptable. This information could be shared, and optionally, a standard established and promulgated for the PWL.

The administrator 136 can also be responsible for creating the tokens representing SGUs and PWLs, providing them to the participant, e.g., user 132, and archiving them when appropriate in a database and/or on a distributed ledger such as a blockchain.

While it is recommendable that there be only one administrator within the ecosystem 10, this disclosure is not limited to thereto and there may be scenarios where multiple administrators are desired. And the administrator 136 could also be the group/entity that operates the system 108 or has contract functions. When there is a need for any outside platforms to back into or out of this SGU ecosystem, which is expected to be the case, it would preferably be approved/authorized by the administrator 136.

Additionally, the trustee 144, who can be an independent validator of the gold, preferably inputs details (such as purity, weight, and location) of gold (or another commodity) into the database 120, once approved by the administrator 136 in an optional configuration, so that it has been registered into the trusted ecosystem. By doing so, the trustee 144 confirms and validates that there is physical gold 104 to back an SGU.

The trustee 144 also optionally takes on the responsibility of the legal ownership of the physical gold 104 when the gold has been calculated, digitalized and represented as SGUs. Once all verification checks have been completed, trustees can retain ownership of the physical gold until the digitalized SGUs have been archived. The trustees are optionally a separate legal structure distinct from the administrator 136. There can be many trustees 144 within the ecosystem 10, with an optional configuration being to have one trustee 144 at each secure gold storage location 100.

The database 120 can be used to trace the universal integrity and provenance of a commodity, such as gold 104, being provided to trustees 144 by producers of the commodity, such as miners, refiners, custodians, users and investors. Again, that data can be passed to the trustee 144 and linked to information about the gold being stored in a repository 100 by the trustee 144.

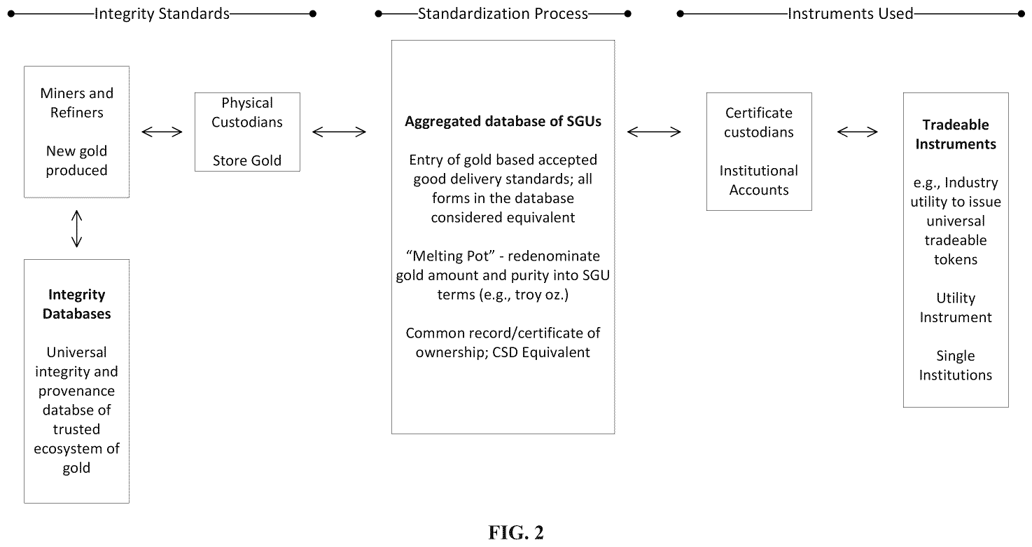

The data in the database 120 can also be made available to the administrator 136. FIG. 2 described how the database is constructed, with this functionality being implementable in the ecosystem 10. The ecosystem 10 allows and facilitates the tokens can be deposited into an account (not shown) of an owner or custodian, sometimes referred to as a participant, noting these accounts can be regional, national, or international in nature. As discussed, the ecosystem 10 enables the products to be bought and sold as tradeable instruments or leveraged as utility tokens.

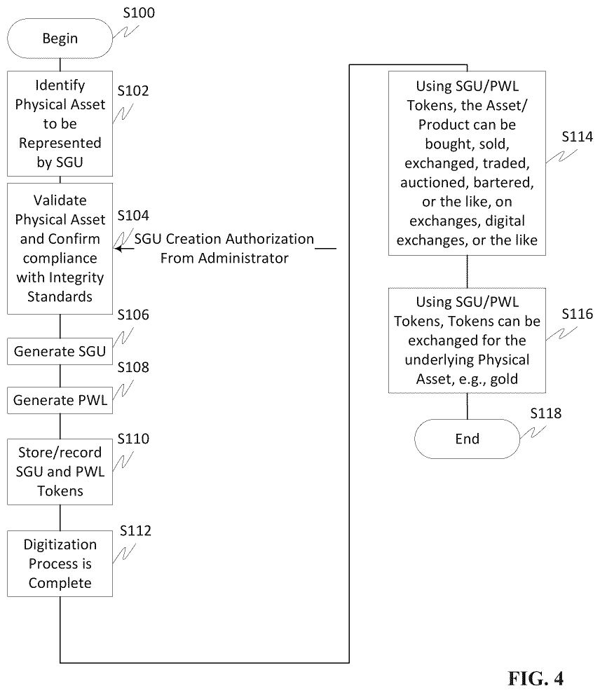

FIG. 4 illustrates an exemplary method for generating and managing SGUs and PWLs in accordance with an exemplary embodiment. The process begins in step S100 and continues to step S102. In step S102, one or more assets, such as gold, are identified as to be represented by an SGU/PWL. Next in step S104, and after authorization from an administrator, the physical asset(s) is validated to exist and be in conformance with integrity standards. Then, in step S106 the SGU is created and in step S108 the PWL generated. Control then continues to step S110.

In Step S110, the generated SGU and PWL tokens are stored and/or recorded, such as on a distributed ledger system, for example, a blockchain. Next, in step S112 the digitization process for the physical asset is complete and has the exemplary advantages/benefits discussed herein. For example, as outlined in step S114, the SGU/PWL tokens, the underlying physical asset(s)/product(s) can be bought, sold, exchanged, traded, auctioned, bartered, or the like, on exchanges, digital exchanges, or the like. Then, in step S116, the SGU/PWL tokens, the tokens can be exchanged or “traded in” for the underlying physical asset(s), e.g., gold. Control then continues to step S118 where the control sequence ends.

It is to be understood that these embodiments are merely examples and that the systems and methods described can be embodied in various forms. Therefore, specific structural and functional details disclosed herein are not to be interpreted as limiting, but merely as a basis for any claims to be pursued and as a representative basis for teaching one skilled in the art to variously employ the present subject matter in virtually any appropriately detailed structure and function. Further, the terms and phrases used herein are not intended to be limiting, but rather, to provide an understandable description of the concepts.

Any of the steps, functions, and operations discussed herein can be performed continuously and automatically.

While the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer(s), a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), smartphones, and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated system, system component, or the like. The system can also be implemented by physically incorporating the system and/or method into a software and/or hardware system.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate exemplary embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Example aspects of the present disclosure include:

A system comprising:
at least one server having memory;
a database stored in memory;
wherein the database stores information associated with of a unique and linked standardized gold unit (SGU) token and a unique and linked Purity, Weight & Location (PWL) token;
wherein the database retains a unique number for each stored PWL token;
wherein an account number of a PWL token is changeable; and
wherein information associated with the unique and linked SGU token and the PWL token cannot be changed in the database.

Any one or more of the above aspects, wherein the SGU token and the PWL token are associated with a physical asset.

Any one or more of the above aspects, wherein the physical asset is gold.

Any one or more of the above aspects, wherein authorization from an authorized SGU creator provides validation that the physical asset exists and conforms with integrity standards.

Any one or more of the above aspects, wherein the physical asset is stored in a secure repository.

Any one or more of the above aspects, wherein the physical asset is stored in a secure repository and redeemable or exchangeable upon presentation of the SGU token.

Any one or more of the above aspects, wherein the SGU token and the PWL token are stored on a distributed ledger.

Any one or more of the above aspects, wherein the SGU token is able to be bought, sold, exchanged, traded, auctioned, and/or bartered.

Any one or more of the above aspects, wherein the SGU token and PWL token provide a useful, concrete and tangible product that does not require physically relocating an underlying physical asset to effect an ownership transfer of the physical asset.

A method comprising:
identifying a physical asset to be represented by a standardized gold unit (SGU) token and a unique and linked Purity, Weight & Location (PWL) token;
generating the SGU token;
generating the linked PWL token; and
immutably storing the SHU token and the PWL token.

Any one or more of the above aspects, further comprising validating existence, quality and integrity of the physical asset.

Any one or more of the above aspects, further comprising exchanging the SGU token for the physical asset.

Any one or more of the above aspects, wherein the generating and storing steps are a digitization of the physical asset.

Any one or more of the above aspects, further comprising a SGU token holder buying, selling, exchanging, trading, auctioning, and/or bartering the SGU token.

Any one or more of the above aspects, wherein the immutably storing is on a distributed ledger

Any one or more of the above aspects, further comprising receiving authorization from a SGU creation administrator to generate the SGU token.

Any one or more of the above aspects, wherein the SGU token and the PWL token are associated with a physical asset.

Any one or more of the above aspects, wherein the physical asset is gold.

Any one or more of the above aspects, further comprising redeeming or exchanging the physical asset from a secured repository upon presentation of the SGU token.

A non-transitory computer-readable information storage media having instructions stored thereon, that when executed by one or more processors, perform a method comprising:
identifying a physical asset to be represented by a standardized gold unit (SGU) token and a unique and linked Purity, Weight & Location (PWL) token;
generating the SGU token;
generating the linked PWL token; and
immutably storing the SHU token and the PWL token.

A system comprising:
means for identifying a physical asset to be represented by a standardized gold unit (SGU) token and a unique and linked Purity, Weight & Location (PWL) token;
means for generating the SGU token;
means for generating the linked PWL token; and
means for immutably storing the SHU token and the PWL token One or more
means to implement any one or more of the features disclosed herein.

Any of the above aspects in combination with any one or more other of the above aspects.

Any one or more of the features disclosed herein.

Any one or more of the features as substantially disclosed herein.

One or more means for preforming any one or more of the above aspects.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

It is therefore apparent that there has been provided systems and methods for a new SGU. While the embodiments have been described in conjunction with a number of embodiments, it is evident that many alternatives, modifications and variations would be or are apparent to those of ordinary skill in the applicable art(s). Accordingly, this disclosure is intended to embrace and include all such alternatives, modifications, equivalents and variations that are within the spirit and scope of this technical disclosure.

1. A system comprising:
at least one server having memory;
a database stored in memory;
wherein the database stores information associated with of a unique and linked standardized gold unit (SGU) token and a unique and linked Purity, Weight & Location (PWL) token;
wherein the database retains a unique number for each stored PWL token;
wherein an account number of a PWL token is changeable; and
wherein information associated with the unique and linked SGU token and the PWL token cannot be changed in the database.

2. The system of claim 1, wherein the SGU token and the PWL token are associated with a physical asset.

3. The system of claim 2, wherein the physical asset is gold.

4. The system of claim 2, wherein authorization from an authorized SGU creator provides validation that the physical asset exists and conforms with integrity standards.

5. The system of claim 2, wherein the physical asset is stored in a secure repository.

6. The system of claim 2, wherein the physical asset is stored in a secure repository and redeemable or exchangeable upon presentation of the SGU token.

7. The system of claim 1, wherein the SGU token and the PWL token are stored on a distributed ledger.

8. The system of claim 1, wherein the SGU token is able to be bought, sold, exchanged, traded, auctioned, and/or bartered.

9. The system of claim 1, wherein the SGU token and PWL token provide a useful, concrete and tangible product that does not require physically relocating an underlying physical asset to effect an ownership transfer of the physical asset.

10. A method comprising:
identifying a physical asset to be represented by a standardized gold unit (SGU) token and a unique and linked Purity, Weight & Location (PWL) token;
generating the SGU token;
generating the linked PWL token; and
immutably storing the SHU token and the PWL token.

11. The method of claim 10, further comprising validating existence, quality and integrity of the physical asset.

12. The method of claim 10, further comprising exchanging the SGU token for the physical asset.

13. The method of claim 10, wherein the generating and storing steps are a digitization of the physical asset.

14. The method of claim 10, further comprising a SGU token holder buying, selling, exchanging, trading, auctioning, and/or bartering the SGU token.

15. The method of claim 10, wherein the immutably storing is on a distributed ledger

16. The method of claim 10, further comprising receiving authorization from a SGU creation administrator to generate the SGU token.

17. The method of claim 10, wherein the SGU token and the PWL token are associated with a physical asset.

18. The method of claim 17, wherein the physical asset is gold.

19. The method of claim 17, further comprising redeeming or exchanging the physical asset from a secured repository upon presentation of the SGU token.

20. A non-transitory computer-readable information storage media having instructions stored thereon, that when executed by one or more processors, perform a method comprising:
identifying a physical asset to be represented by a standardized gold unit (SGU) token and a unique and linked Purity, Weight & Location (PWL) token;
generating the SGU token;
generating the linked PWL token; and
immutably storing the SHU token and the PWL token.

21. A system comprising:
means for identifying a physical asset to be represented by a standardized gold unit (SGU) token and a unique and linked Purity, Weight & Location (PWL) token;
means for generating the SGU token;
means for generating the linked PWL token; and
means for immutably storing the SHU token and the PWL token.
